(19) United States
(12) Patent Application Publication
(10) Pub. No.: US 2018/0046957 A1
(43) Pub. Date: Feb. 15, 2018

(54) Online Meetings Optimization

(71) Applicant: Microsoft Technology Licensing, LLC, Redmond, WA (US)

(72) Inventors: Ronen Yaari, TEL AVIV (IL); Ola Lavi, Hertzliya (IL); Royi Ronen, TEL AVIV (IL); Eyal Itah, HOD HASHARON (IL)

(21) Appl. No.: 15/232,440

(22) Filed: Aug. 9, 2016

(51) Int. Cl. G06Q 10/06; G06Q 10/10; G06N 5/02; H04L 29/06

(52) U.S. Cl. CPC G06Q 10/0639; H04L 65/403; G06Q 10/1095; G06N 5/022; G06Q 10/06398

(57) ABSTRACT

Technologies are provided for determining effectiveness of online meetings and providing actionable recommendations and insights based, in part, on a determined effectiveness of the online meetings. According to one embodiment, a measurement of the effectiveness, with respect to meeting participants of proposed, future meetings is predicted, and based on this, aspects of the proposed future meetings are optimized to maximize their effectiveness. Another embodiment relates to optimizing current online meetings as they occur. The ongoing meetings are monitored and data associated with the meetings is analyzed to provide recommendations and insights to meeting presenters and participants in real-time, or near real-time.

### BACKGROUND

Online meetings have become increasingly common in many work environments. Often, a significant amount of time is spent by employees participating in these meetings. However, some online meetings are not effective or essential for a given employee or employees. Additionally, methods for analyzing the effectiveness of online meetings are in their infancy. Accordingly, employees and organizations may not have an adequate way to determine which meetings are an effective use of employee time.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present disclosure relate systems and methods for determining effectiveness of online meetings and providing actionable recommendations/insights based, in part, on the determined effectiveness. The features may be detected from correlated meeting data, such as a meeting invitation, or may be determined from data that was sensed, recorded, or tracked during the meeting. The determined meeting features may be used to evaluate effectiveness or productivity of a meeting. Effectiveness scores that reflect the meeting's effectiveness may be generated and, in one example, be represented as numeric values. Additionally, the effectiveness scores may be determined at a global level, which reflects how effective a meeting was for all participants. Further, the effectiveness of a meeting may be determined for each participant. The participant-specific effectiveness scores may include an overall participant effectiveness score, which represents how effective a given meeting was for a user across all features.

Additionally, any number of inferences or patterns may be gleaned from the effectiveness scores and related data. As can be appreciated, the inferences and/or patterns may be determined at a global level, or for each participant. As a result, patterns relating to each participant and effectiveness scores for any number of features may be identified and clustered, or grouped, to provide models for predicting an effectiveness of future meetings for the participant.

Another aspect provided herein relates to predicting effectiveness of future meetings, and optimizing future meetings to maximize effectiveness. In some aspects, features of a proposed/future meeting may be detected. The proposed meeting features may be used to identify prior similar meetings at both a global and per participant level. The identified similar prior meetings and associated effectiveness scores may be used to predict an effectiveness score or scores for the proposed meeting. Further, recommended meeting features may be generated that optimize the predicted effectiveness score for the future meeting.

Yet another embodiment relates to optimizing live online meetings. Ongoing meetings may be monitored and data associated with the meetings may be analyzed to provide recommendations/insights to meeting presenters and participants in real-time, or near real-time. Features of a live meeting may be extracted in order to identify prior meetings with similar features, and associated effectiveness scores and/or patterns. Additionally, recommendations/insights for presenters and passive participants can be generated and communicated in real-time while the meeting is ongoing.

### BRIEF DESCRIPTION OF THE DRAWINGS

The present disclosure is described in detail below with reference to the attached drawing figures, wherein:

FIG. 1 is a block diagram of an exemplary computing environment suitable for use in implementing embodiments of the present disclosure;

FIG. 2 is a block diagram illustrating an exemplary online meeting optimization system in which some embodiments of the present disclosure may be employed;

FIG. 3 is a diagram illustrating an exemplary live meeting optimization system in which some embodiments of the present disclosure may be employed;

FIG. 4 is a flow diagram that illustrates a method for providing one or more recommendations for an online meeting;

FIG. 5 is a flow diagram that illustrates a method for providing one or more recommendations for a live online meeting; and

FIG. 6 is a block diagram that illustrates an exemplary computing device.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

Aspects of this disclosure provide systems and methods for determining effectiveness of online meetings to providing actionable recommendations/insights based, in part, on the determined effectiveness. At a high level, in an embodiment, online meetings may be monitored in order to identify meetings that have been conducted and to determine features associated with the meetings. Some features may be detected from related meeting data, such as a meeting invitation, or other correspondence associated with the meeting. By way of example, features relating to a time and day of the meeting, a meeting subject, a meeting organizer, among others, may be detected from the meeting invitation. Other features, however, may be derived from data that is sensed, recorded, or tracked during a meeting. In one example, the sensed data may include audio or video recording(s) of the online meeting, which may be converted into text in order to deduce meeting features. Continuing with this example, the text may be analyzed to determine meeting features such as, without limitation, topics discussed, an identification of a presenter or contributor, an amount of time that the presenter or other meeting participant spoke. Additionally, the sensed data may include engagement and/or activity data for all meeting participants, including passive participants that did not present or contribute. The engagement/activity data also may be used to derive a variety of other features for the meeting. For example, a participant focus feature may be determined from engagement data relating to performance of peripheral tasks (e.g., tasks unrelated to the meeting, such as emailing, instant messaging, texting, etc.), while the meeting was being conducted.

In another aspect, the determined meeting features may be used to evaluate effectiveness or productivity of a meeting. In particular, effectiveness scores that reflect the meeting's effectiveness may be generated and, in one example, may be represented as numeric values. Effectiveness scores may be determined based on derived meeting effectiveness data and/or explicit meeting effectiveness data. For instance, derived effectiveness scores may be determined, for example, using rules or heuristics as further described herein. Explicit meeting effectiveness scores may be determined from explicit feedback provided by participants, including questionnaires, surveys, or any other type of explicit participant feedback. In some aspects, the derived effectiveness scores and explicit effectiveness scores may be combined to determine a resulting effectiveness score.

Additionally, effectiveness scores may be determined at a global level, which reflects how effective a meeting was for all participants. The global effectiveness score may include an overall score, or aggregation of derived and explicit effectiveness scores for all meeting features. The global effectiveness score may also include feature specific effectiveness scores, which reflect aggregate effectiveness scores for all participants for all meeting features. For example, effectiveness scores of each meeting participant with respect to a time/day feature may be aggregated to determine a global time/day effectiveness score.

Further, the effectiveness of a meeting may be determined for each participant. The participant-specific effectiveness scores may include an overall participant effectiveness score, which represents how effective a given meeting was for a user across all features. Additionally, participant-specific effectiveness scores may be determined with respect to each feature associated with the meeting. For example, a participant effectiveness score may be determined for a duration feature, which represents the effectiveness of the meeting based on how long the meeting was. In another example, a participant effectiveness score may be determined for a participant relevance feature, which may represent how relevant a topic of the meeting was to the participant, for example based on the participant's specialty or area of expertise. Combining the above examples, the participant duration effectiveness score for the meeting may be low, for example if the meeting was two hours long and one hour is an effective duration for the participant, while the participant relevance effectiveness score may be high, for example if the meeting topic was data security and the participant's area of expertise is data security. Accordingly, the participant duration effectiveness score, the participant relevance effectiveness score, and effectiveness scores for all other features of the meeting may be combined or aggregated to determine a participant-specific overall effectiveness score. In an embodiment, the combined or resulting effectiveness scores may be represented as a vector.

Additionally, inferences or patterns may be gleaned from the effectiveness scores and related data. As can be appreciated, the inferences and/or patterns may be determined at a global level, or at the participant level (i.e., for each participant). Global inferences may be determined, in part, based on global effectiveness scores and related data for all meetings across the system. For example, global effectiveness scores for each feature of all prior meetings may be identified and associated with contextual information related to the features.

Still further, using the determined meeting features, global meeting patterns may be determined by identifying semantically related features and determining correlations between the features. Accordingly, meetings having similar patterns and/or similar global effectiveness scores for a given feature may be clustered or grouped to provide models for determining inferences regarding future meetings or proposed future meetings. Similarly, the participant inferences and/or patterns may be determined based on participant effectiveness scores and related data for all meetings in which a participant has participated. As a result, patterns relating to each participant and effectiveness scores for any number of features may be identified and clustered, or grouped, to provide models for predicting a measure of effectiveness of future meetings (including proposed future meetings) for the participant.

Another aspect provided herein relates to predicting effectiveness of future meetings and providing recommendations to optimize future meetings in order to maximize effectiveness. In some embodiments, features of a proposed/future meeting are detected. The proposed-meeting features may be used to identify prior similar meetings at a global and/or per-participant level. For example, the proposed meeting features may include a day/time feature that can be used to identify prior meetings with a similar day/time features and corresponding global effectiveness scores. Additionally, the proposed features may include participants or presenters with patterns associated with the detected features. Accordingly, participant effectiveness scores for prior similar meetings, or historical meetings having common features with the proposed meeting, may be identified for each participant. The set of identified similar prior meetings and their corresponding effectiveness scores then may be used to infer an effectiveness score (or scores) for the proposed meeting. Further, recommended meeting features may be generated that optimize the inferred effectiveness score for the future meeting.

Yet another embodiment relates to optimizing live online meetings. Ongoing meetings may be monitored in real-time and data associated with the meetings may be analyzed to provide recommendations/insights to meeting presenters and participants in real-time, or near real-time. Features of a live meeting may be extracted, as described previously, in order to identify prior meetings with similar features, and associated effectiveness scores and/or patterns. In some aspects, features of a live meeting may be determined prior to the meeting, for example, from a meeting invitation. Accordingly, meeting patterns relating to the determined features may be determined and prepared for comparison to additional features determined during the meeting. Features determined dynamically during a meeting may include an identity of a presenter or contributor, and a topic which they are discussing. Further, features associated with passive participants of the meeting also may be determined. For instance, engagement data for a passive participant, such as messaging or chatting about the meeting, may be identified during the meeting. Additionally, recommendations/insights for presenters and passive participants can be generated and communicated in real-time while the meeting is ongoing. For example, a private message may be communicated to a moderator suggesting that a given participant should be engaged or involved. Such a recommendation may be generated, in one example, based on a determination that the current topic being discussed is associated with an area of expertise of the given participant and the given participant has not yet commented on the topic. In another example, a notification/recommendation may be communicated to a passive participant when a specific presenter is determined to be speaking. For instance, a notification may be generated and communicated to a passive participant if it is determined that the passive participant's boss is currently presenting.

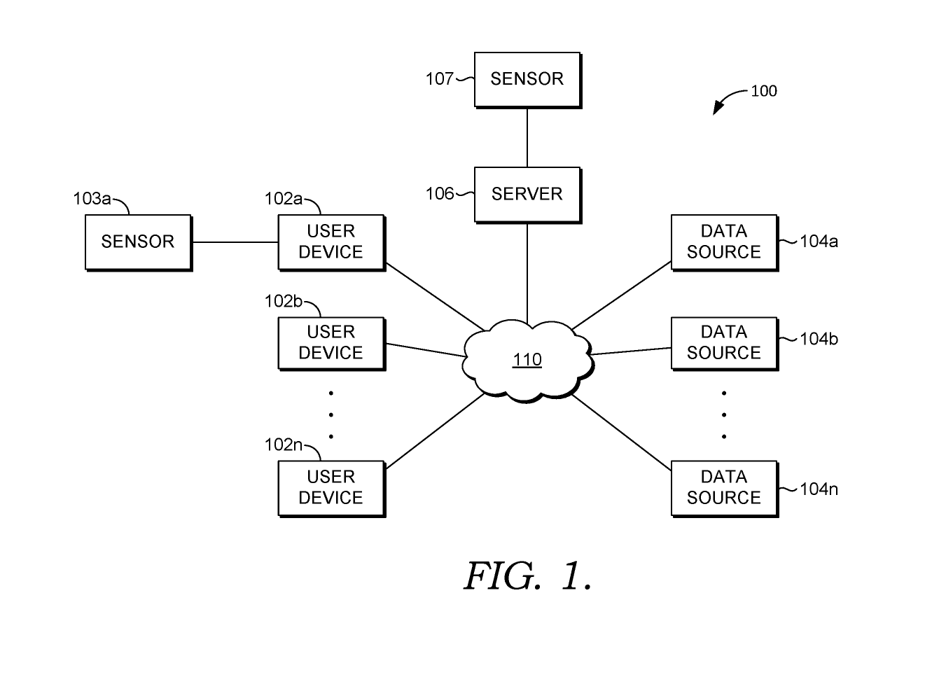

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

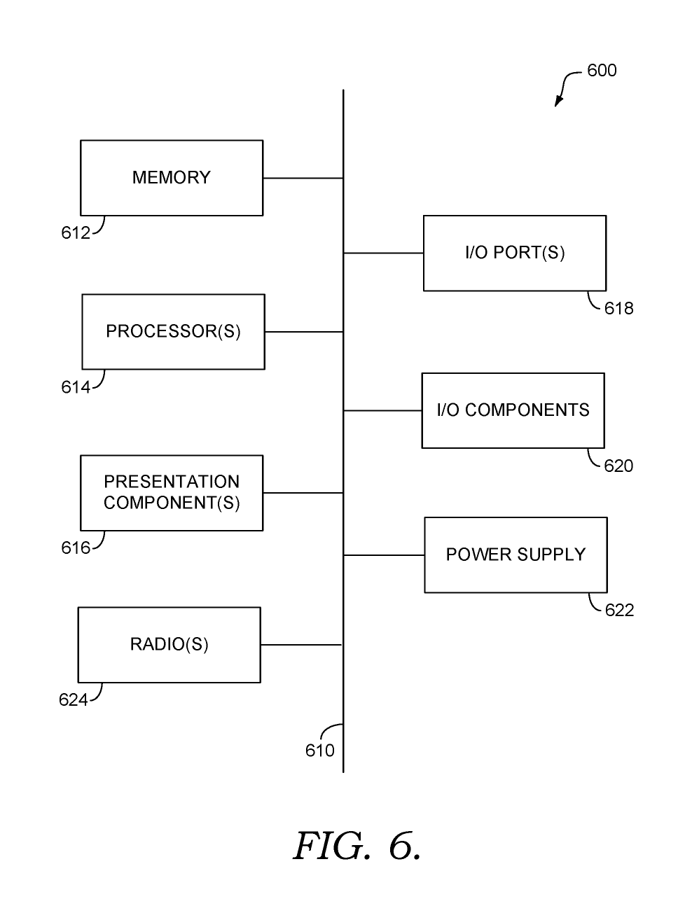

Among other components not shown, example operating environment 100 includes a number of user devices, such as user devices 102a and 102b through 102n; a number of data sources, such as data sources 104a and 104b through 104n; server 106; sensors 103a and 107, and network 110. It should be understood that environment 100 shown in FIG. 1 is an example of one suitable operating environment. Each of the components shown in FIG. 1 may be implemented via any type of computing device, such as computing device 600, described in connection to FIG. 6, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 maybe provided via multiple devices arranged in a distributed environment that collectively provide the functionality described herein. Additionally, other components not shown may also be included within the distributed environment.

User devices 102a and 102b through 102n may comprise any type of computing device capable of use by a user. For example, in one embodiment, user devices 102a through 102n may be the type of computing device described in relation to FIG. 6 herein. By way of example and not limitation, a user device may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, a camera, remote control, a bar code scanner, a computerized measuring device, appliance, consumer electronic device, a workstation, or any combination of these delineated devices, or any other suitable device.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

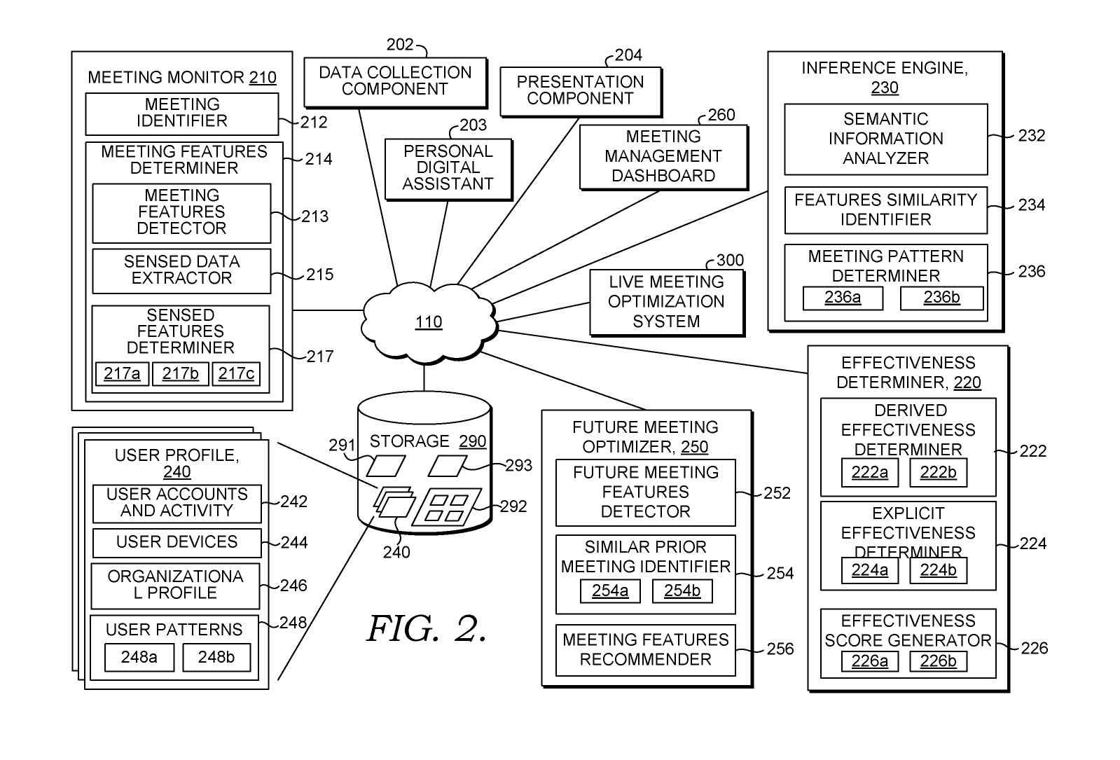

Data sources 104a and 104b through 104n may comprise data sources and/or data systems, which are configured to make data available to any of the various constituents of operating environment 100, or online meeting optimization system 200 described in connection to FIG. 2. For instance, in one embodiment, one or more data sources 104a through 104n provide (or make available for accessing) data collection component 202 of FIG. 2. Data sources 104a and 104b through 104n may be discrete from user devices 102a and 102b through 102n and server 106 or may be incorporated and/or integrated into at least one of those components. In one embodiment, one or more of data sources 104a though 104n comprises one or more sensors, which may be integrated into or associated with one or more of the user device(s) 102a, 102b, or 102n or server 106. Examples of sensed meeting data made available by data sources 104a though 104n are described further in connection to data collection component 202 of FIG. 2.

Operating environment 100 can be utilized to implement one or more of the components of online meeting optimization system 200, described in FIG. 2, including components for collecting user data, inferring meeting patterns, generating meeting attendance models, generating meeting details or features, and/or presenting meeting invitations and related content to users.

Turning now to FIG. 2, a block diagram is provided illustrating an exemplary online meeting optimization system 200 in which some embodiments of the present disclosure may be employed. The online meeting optimization system 200 includes network 110, which is described in connection to FIG. 1, and which communicatively couples components of online meeting optimization system 200. The components of online meeting optimization system 200 may be embodied as a set of compiled computer instructions or functions, program modules, computer software services, or an arrangement of processes carried out on one or more computer systems, such as computing device 600 described in connection to FIG. 6, for example.

In one embodiment, the functions performed by components of online meeting optimization system 200 are associated with one or more personal assistant applications, services, or routines. In particular, such applications, services, or routines may operate on one or more user devices (such as data sources 104a), servers (such as server 106), may be distributed across one or more user devices and servers, or be implemented in the cloud. Moreover, in some embodiments these components of online meeting optimization system 200 may be distributed across a network, including one or more servers (such as server 106) and client devices (such as user device 102a), in the cloud, or may reside on a user device such as user device 102a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments of the disclosure described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regard to specific components shown in example online meeting optimization system 200, it is contemplated that in some embodiments functionality of these components can be shared or distributed across other components.

As noted above, it should be understood that the online meeting optimization system 200 shown in FIG. 2 is an example of one system in which embodiments of the present disclosure may be employed. Each component shown may include one or more computing devices similar to the operating environment 100 described with reference to FIG. 1. The online meeting optimization system 200 should not be interpreted as having any dependency or requirement related to any single module/component or combination of modules/components illustrated therein. Each may comprise a single device or multiple devices cooperating in a distributed environment. For instance, the online meeting optimization system 200 may comprise multiple devices arranged in a distributed environment that collectively provide the functionality described herein. Additionally, other components not shown may also be included within the network environment. It should be understood that the online meeting optimization system 200 and/or its various components may be located anywhere in accordance with various embodiments of the present disclosure.

The online meeting optimization system 200 generally operates to determine meeting effectiveness scores, determine meeting patterns and inferences, and provide services for optimizing future and live meetings. As briefly mentioned above, each component of the online meeting optimization system 200, including data collection component 202, presentation component 204, inference engine 230, meeting attendance model generator 240, user profile 240, future meeting optimizer 250, and meeting monitor 210, and their respective subcomponents, may reside on a computing device (or devices). For example, the components of online meeting optimization system 200 may reside on the exemplary computing device 600 described below and shown in FIG. 6, or similar devices. Accordingly, each component of the online meeting optimization system 200 may be implemented using one or more of a memory, a processors or processors, presentation components, input/output (I/O) ports and/or components, radio(s) and a power supply (e.g., as represented by reference numerals 612-624, respectively, in FIG. 6).

Data collection component 202 is generally responsible for collecting online meeting data and user data, which may be made available to the other components of online meeting optimization system 200 (and live meeting optimization system 300, as will be discussed in further detail below). In some aspects, the data collected by the data collection component 202 includes meeting data elements (or meeting features) of meetings or events, and the data collection component 202 may be configured to associate each of the meeting data elements with an online meeting, and to store the associated meeting data elements, for example, in meeting storage 292. The online meeting data may include a meeting invitation, or other correspondence associated with the meeting, electronic documents included in or associated with the meeting, and any other meeting related data. Further, the data collection component may collect, detecting, or otherwise obtain data that is sensed, recorded, or tracked during a meeting. In one example, the sensed data may include audio or video recording(s), of the online meeting, which may be in a compressed, and/or a packetized format. Further, the data collection component 202 may be responsible for detecting signals corresponding to online meetings and providing the detected signals to the other components of online meeting optimization system 200.

In some aspects, a personal digital assistant program (PDA) 203 or similar application or service (sometimes referred to as virtual assistant), such as Microsoft Cortana®, may also be responsible for collecting, facilitating sensing, interpreting, detecting, or otherwise obtaining online meeting data. PDAs that operate on a user device, across multiple user devices associated with a user, in the cloud, or a combination of these, are a newer technology that promises to improve user efficiency and provide personalized computing experiences. A PDA may provide some services traditionally provided by a human assistant. For example, a PDA may update a calendar, provide reminders, track activities, and perform other functions. Some PDAs can respond to voice commands and audibly communicate with users. For example, Personal digital assistant 203, in one embodiment, may act as a participant in online meetings in order to obtain online meeting data associated with the meetings. In one aspect, data collection component 202 may access the online meeting data obtained by the personal digital assistant 203 and make the online meeting data available to other components of online meeting optimization system 200 to determine meeting features, for example, as described in more detail with reference to meeting features determiner 214. Additionally, some embodiments of personal digital assistant 203 may perform the operations, or facilitate carrying out operations performed by, other components (or subcomponents) of systems 200 or 300.

The data collection component 202 may also be responsible for collecting, sensing, detecting, or otherwise obtaining user data. User data, which may include meeting data, may be received from a variety of sources where the data may be available in a variety of formats. For example, in some embodiments, user data received via data collection component 202 may be determined via one or more sensors (such as sensors 103a and 107 of FIG. 1), which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both.

Additionally, user data, particularly in the form of event data and/or location data can be received by data collection component 202 from one or more computing devices associated with a user. While it is contemplated that the user data is processed, by the sensors or other components not shown, for interpretability by data collection component 202, embodiments described herein do not limit the user data to processed data and may include raw data. In some embodiments, the user data, including meeting related information, is stored in a user profile, such as user profile 240. Information about user devices associated with a user may be determined from the user data made available via data collection component 202, and maybe provided to meeting monitor 210, inference engine 230, or other components of online meeting optimization system 200. In some implementations of meeting monitor 210, a user device may be identified by detecting and analyzing characteristics of the user device, such as device hardware, software such as operating system (OS), network-related characteristics, user accounts accessed via the device, and similar characteristics. For example, information about a user device may be determined using functionality of many operating systems to provide information about the hardware, OS version, network connection information, installed application, or the like.

By way of example and not limitation, user data may include data that is sensed or determined from one or more sensors (referred to herein as sensor data), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user data associated with communication events; etc.) including user activity that occurs over more than one user device, user history, session logs, application data, contacts data, calendar and schedule data, notification data, social network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personalization-related (e.g., “personal assistant,” such as Cortana®) application or service, home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, payment or credit card usage data (which may include information from a user's PayPal account), purchase history data (such as information from a user's Amazon.com or eBay account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, cellular network, or IP address data), and nearly any other source of data that may be sensed or determined as described herein. In some embodiments, user data may be provided in user-data streams or “user signals,” which can be a feed or stream of user data from a data source. For instance, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, data collection component 202 receives or accesses data continuously, periodically, or as needed.

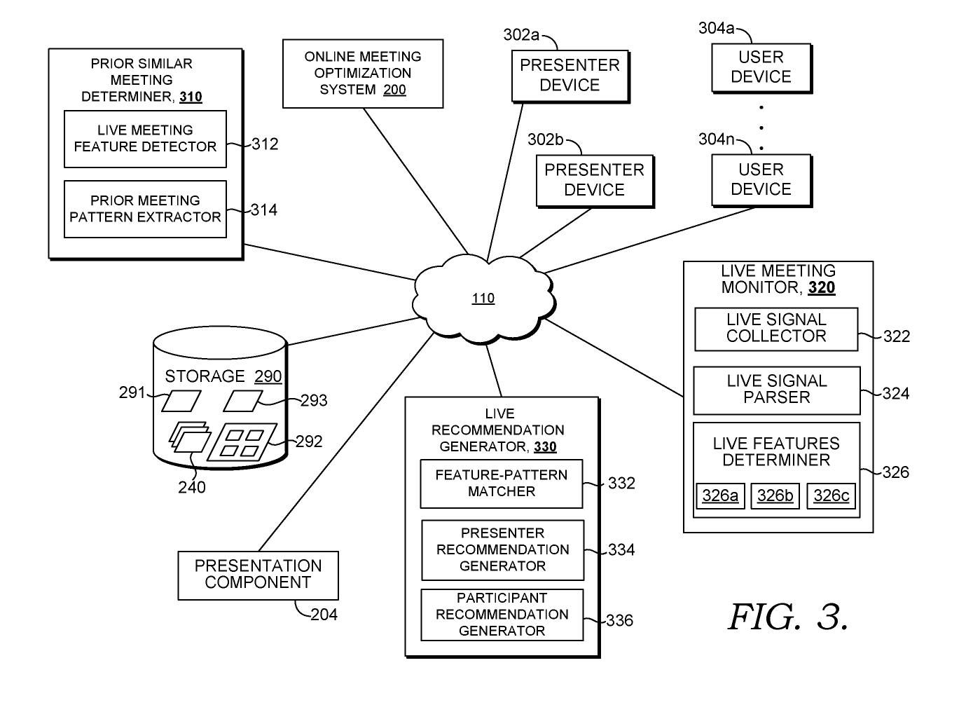

Presentation component 204 generally operates to render various user interfaces or otherwise provide information generated by the online meeting optimization system 200, and the components thereof, in a format that can be displayed on a user device. By way of example, the presentation component 204 may render recommended meeting features determined by future meeting optimizer 250, and live meeting recommendations generated by live recommendation generator 330 (described with reference to FIG. 3). In some aspects, the presentation component 204 may also render a meeting management dashboard 260 interface.

Meeting monitor 210 is generally responsible for determining and/or detecting meeting features from online meetings, and making the meeting features available to the other components of online meeting optimization system 200. In some aspects, meeting monitor 210 determines and provides a set of meeting features (such as described below), for a particular meeting, and for each user associated with the meeting. In some aspects, the meeting may be a past (or historic) meeting, or a current meeting. Further, it should be appreciated that the meeting monitor 210 may be responsible for monitoring any number of meetings, for example, each online meeting associated with online meeting optimization system 200. Accordingly, the features corresponding to the online meetings determined by meeting monitor 210 may be used to analyze a plurality of meetings and determine corresponding patterns (e.g., by inference engine 230).

Meeting identifier 212, in general, is responsible for determining (or identifying) meetings that have occurred, associating the identified meetings with the related meeting data, and, in one aspect, providing the identified meetings and associated data to meeting features determiner 214. For example, in one embodiment, logic 291 may include comparing meeting detection criteria with the data collected by data collection component 202 and/or personal assistant 203, which may be stored in storage 290 in order to determine that a meeting has occurred. As can be appreciated, the meeting identifier 212 may employ meeting related data that has already been associated with a meeting, and which may be stored in meeting storage 292, in conjunction with logic 291 and data stored in storage 290 which has not been associated with a specific meeting.

In some embodiments, the identification and/or classifying of meetings can be based on feature-matching or determining similarity in features, which may be carried out using statistical classification processes Thus, logic 291 may comprise pattern recognition classifier(s), fuzzy logic, neural network, finite state machine, support vector machine, logistic regression, clustering, or machine learning techniques, similar statistical classification processes or, combinations of these to identify meetings from user data. Accordingly, the logic 291 can take many different forms depending on the mechanism used to identify a meeting, and may be stored in storage 290. For example, logic 291 might include training data used to train a neural network that is used to evaluate user data to determine when a meeting has occurred. Moreover, logic 291 may specify types of meeting features or user activity such as specific user device interaction(s), that are associated with a meeting, accessing a schedule or calendar, accessing materials associated with a meeting (e.g. an agenda or presentation materials), composing or responding to a meeting request communication, acknowledging a notification, navigating to a website, or launching an app. In some embodiments, a series or sequence of user-related activity may be mapped to a meeting, such that the meeting may be detected upon determining that the user data indicates the series or sequence of user-related activity has occurred or been carried out by the user.

Accordingly, the meeting identifier 212 may identify meeting, related meeting data, which may include a meeting invitation, or other correspondence associated with the meeting, electronic documents included in or associated with the meeting, sensed data, including shared documents, presentations, whiteboards, shared screens, audio or video recording(s) of the online meeting, user activity and engagement data tracked during the meeting, and any other meeting related data.

Meeting features determiner 214 is generally responsible for determining meeting-related features (or variables) associated with the meeting, and related users, including presenters and participants. Meeting features determiner 214 may receive and analyze the related meeting data identified by meeting identifier 212 to detect, extract, and/or determine features associated with the online meeting. The meeting features determiner 214 may include a meeting features detector 213, a sensed data extractor 215, and a sensed features determiner 217.

Meeting features detector 213 may operate to detect meeting features from the related meeting data, for example from a meeting invitation and/or documents related to the meeting. Any number of features may be detected by the meeting features detector 213 from meeting related documents, for example: time/date; scheduled duration; participants; file attachments or links in meeting-related communications; which may include content of the attachments or links; metadata associated with file attachments or links (e.g., author, version number, date, URL or website-related information, etc.); whether the meeting is recurring; and meeting features from previous meetings or future meetings (where the meeting is part of a series, such as recurring meetings). The above features are exemplary only, and are not intended to limit the features detected by meeting features detector 213. Meeting features detector 213 may also detect feedback relating to the effectiveness of the meeting. For example, explicit feedback provided by participants, including questionnaires, surveys, or any other type of explicit participant feedback, may be detected by meeting features detector 213.

Sensed data extractor 215 may be responsible for extracting sensed data identified by the meeting identifier 212, and converting the sensed data into usable formats for consumption by sensed features determiner 217, and the other components of online meeting optimization system 200. For example, the sensed data extractor may extract compressed audio or video recording(s) of the online meeting and decompress the recordings. In one aspect, the audio or video recordings of the online meeting may be recorded and compressed by personal assistant 203. In some aspects, where a recording includes both audio and video, the sensed data extractor may identify and separate packetized audio and video data. Further, the sensed data extractor may convert audio data into text, or other format, so that the recording of the meeting may be analyzed to determine additional meeting features.

Further, the sensed data extractor 215 extract participant/user data associated with the meeting, such as device and activity data, for each participant. For example, device usage data for a participant during the time period associated with the meeting may be extracted, for example, from user profile 240, or may be obtained from data collection component 202. User activity and engagement data, and any other meeting related data may include data that is sensed (referred to herein as sensed data) or determined from one or more sensors (including a camera and microphone of a user device), and may include any of the data discussed hereinabove with reference to data collection component 202.

Sensed features determiner 217 is generally responsible for determining features from the sensed data extracted by sensed data extractor 215. For example, the converted audio (which may be in the form of a transcript, in some aspects) from sensed data extractor 215 may be analyzed to determine meeting features such as, without limitation, topics discussed, an identification of a presenter or contributor, or an amount of time that the presenter or other meeting contributor spoke. Additionally, the sensed features determiner 217 may determine engagement and/or activity features for all meeting participants, including passive participants that did not present or contribute. For example, a participant focus feature may be determined from engagement data relating to performance of peripheral tasks (e.g., tasks unrelated to the meeting, such as emailing, instant messaging, texting, etc.), while the meeting was being conducted.

As used herein, the term “participant” may include all users associated with a meeting, including users that presented or contributed during the meeting and users that speculated or observed the meeting, but did not speak or present during the meeting. Further, participants that presented, spoke, or otherwise contributed during the meeting will generally be referred to as “presenters.” Accordingly, discussion relating to presenters indicates that participants that presented or contributed, and discussion relating to participants is generally applicable to both presenters and passive participants. In one aspect, features relating to participants may be determined from the sensed data extracted by sensed data extractor 215 and all other data associated with the meeting, for example the related meeting data identified by meeting identifier 212, and all available data associated with the participants, which may be made available via user profiles 240 and/or data collection component 202. Additionally, sensed features determiner 217 may employ logic 291 (rules, associations, statistical classifiers, etc.) to identify and classify features from the sensed data, meeting related data, and participant related data. The features that may be identified by sensed features determiner 217 will be discussed below, however, the features described are exemplary in nature, and are not intended to be limiting.

Sensed features determiner 217 may include a presenter features determiner 217a that generally operates to determine features related to presenters. In one aspect, a topic associated with a presenter may be determined. For example, a presenter topic feature may be determined by identifying keywords from the transcript created by sensed data extractor 215. In another example, the presenter topic feature may be determined by analyzing specific portions of the presenter's presentation, such as a beginning and end of the presentations, which may include an overview or summary of the topic or topics discussed by the presenter. A presentation duration feature may also be determined, for example, from the recorded audio/video corresponding to the meeting. As can be appreciated, a given presenter may speak or contribute at a number of times during a given meeting. Accordingly, a speaking instances feature may be determined, which represents the number of times the presenter spoke. Further, each speaking instances may include a duration and a topic, which may be determined as described above.

Presenter features determiner 217a may also be responsible for determining an identity of a presenter or contributor. In some aspects, the identity of a presenter may be determined based on a device ID associated with the meeting recording, which may be stored, for example, in user devices 244 of user profile 240. However, in some aspects, an identity of the presenter may not be identifiable based on a device ID, for example, when multiple presenters participate in the meeting using a shared device. Accordingly, sensed features determiner 217 may be configured to analyze the meeting recording and to create a voice signature for each presenter. By way of example, a voice signature may represent a repeating series of frequencies or wavelengths of sound; a specific pattern of frequencies; wavelengths of sound; a specific measurable change in frequencies or wavelength of sound; or simply a specific frequency or wavelength of sound. Additionally, a voice signature may represent a repeating series of changes in amplitude or volume of sound; a specific pattern of changes in amplitude; volume of sound; a specific measurable change in amplitude; volume of sound; or simply a specific amplitude or volume of sound. Further, a voice signature may be defined as any combination of the aforementioned signatures defined by frequency; wavelength of sound and amplitude; volume of sound.

The voice signatures may be compared with existing voice signatures, which may be created when a presenter is using a device with which they are associated, and which may be accessed, for example, via user profile(s) 240. Accordingly, the presenter identity may be determined based on matching an existing voice signature with a voice signatures for the meeting. Additionally, the voice signatures may be used to identify any of the presenter features described herein from the meeting recording. Further, the presenter identity may be used to determine the presenter profile, which may include details relating to the presenter. For example, the presenter profile may include information from organizational profile 246 of the user profile 240 associated with the presenter. As a result, the presenter profile may include organizational data related to the presenter (title, role, hierarchy, etc.), an organizational group or department, an area of expertise or specialization, frequent contacts, networks (including business-related social networks or connections, such as Jammer, Lync, etc.), among others.

Sensed features determiner 217 may also include a participant features determiner 217b, which may be responsible for identifying features related to all meeting participants from, for example, sensed engagement, activity, and/or device data. In one aspect, a variety of features relating to participant engagement in the meeting may be determined. The engagement features may include a meeting interaction feature which may be determined based on user interactions during the meeting, such as commenting on the meeting via a comment or messaging function included in the online meeting platform, and/or interactions related to the meeting conducted via any number of other platforms (e.g., email, instant messaging, etc.). A peripheral activity feature may be determined by detecting performance of peripheral tasks (e.g., tasks unrelated to the meeting, such as emailing, instant messaging, texting, etc.), or use of peripheral devices (e.g., devices associated with the participant other than the device used to participate in the meeting) while the meeting was being conducted.

Additionally, a participant sentiment feature may be determined, which reflects a participant's opinion of or impressions relating to the meeting. For example, sentiments about the meeting may be identified from communications relating to the meeting, including communications within a timeframe corresponding to the meeting, such as communications prior to, during, or after the meeting.

A participant relevance feature may be determined and may reflect a relevance of the meeting topic or topics to a given participant. In one aspect, a participant profile may be determined, in a similar manner as the presenter profiles described hereinabove. The participant profile may include organizational data related to the participant, a group or department, in area of expertise or specialty, frequent contacts, networks, and other data associated with the participant. Accordingly, the meeting topics may be compared to the participant profile to determine a degree of relatedness of the meeting to the participant in light of their area of expertise. Additionally, a relationship feature may be determined for the participant which reflect a participants relationship with meeting presenters and or other participants. For example, the relationship feature may include an indication that the presenter is a participant's supervisor or is at a high level within the organizational hierarchy.

Having discussed example features relating to individual meeting participants, global meeting features determiner 217c will now be addressed. Global meeting features generally relate to features associated with meeting effectiveness for the meeting as a whole, and may include an aggregation of the participant-related features determined by presenter features determiner 217a and/or participant features determiner 217b. In one aspect, a meeting turnout feature may be determined by determining a number of participants that joined more connected to the meeting. In some aspects, the meeting turnout feature may represent a percentage of participants that ultimately join the meeting out of a number of users that were invited to or accepted an invitation to the meeting. An actual meeting duration feature may also be determined, and may represent the actual duration of the meeting, which may be determined from the sensed data. The actual meeting duration feature may include a comparison of the actual meeting duration to a scheduled duration of the meeting, which may be represented by a ratio or other numerical representation.

The global meeting features determiner 217c may also be responsible for determining any number of features from the recorded meeting data and participant engagement data discussed hereinabove. For example, a presenter lineage feature may be determined and may include an identity of each presenter and an order in which they presented. Further, a global meeting topic feature may be identified, for example, by determining the topic or topics addressed by each presenter, which may be determined, in one example, by performing an analysis of the transcript of the meeting, as described hereinabove with reference to individual presenters. Additionally, keywords associated with the meeting may be determined by determining frequently used words or phrases from the recorded meeting data. In another aspect, global meeting features determiner 217c may also determine a global participant engagement feature, which may represent the engagement data determined for some or all meeting participants. Similarly, a global sentiment feature may be determined from the participant sentiment feature for each of the meeting participants.

In some embodiments, the features detected by presenter features determiner 217a, participant features determiner 217b, and/or global meeting features determiner 217c are be represented as vectors. For example, in an embodiment, single or multi-dimensional meeting-features vector is utilized to represent aspects of a particular meeting (or set of meetings, such as a cluster of similar meetings.) For instance, specific features and values associated with the features (such as effectiveness scores, number of participants, speaking duration(s), etc., including binary values, such as whether a meeting is recurring) may be expressed as a vector and utilized by the components and subcomponents of systems 200 (and system 300).

In some embodiments, the features and related online meeting data determined by meeting monitor 210 and relating to specific participants (including presenters), are stored in a user profile, such as user profile 240. An example user profile 240 is shown in FIG. 2, and is generally responsible for storing user-related information, including meeting information, for a particular user. For example, data collected by the data collection component 202 (described hereinabove, including device usage, etc.) may be stored in the user profile 240 in association with a particular user profile. Additionally, data determined from meeting monitor 210, effectiveness determiner 220, and/or inference engine 230, may be stored in user profile 240. The user profile 240 may also operate to provide this stored information to other components of the online meeting optimization system 200 (and 300) for a respective user.

Example user profile 240 includes user accounts and activity 242, user devices 244, organizational profile 246, and user patterns 248. User account(s) and activity data 242 generally includes user data collected from data collection component 202 (which in some cases may include crowd-sourced data that is relevant to the particular user) or other semantic knowledge about the user. In particular, user account(s) and activity data 242 can include data regarding user emails, texts, instant messages, calls, and other communications; social network accounts and data, such as news feeds; online activity; calendars, appointments, or other user data that may have relevance for determining meeting patterns, attendance models, or related meeting information; user availability; and importance, urgency, or notification logic. Embodiments of user account(s) and activity data 242 may store information across one or more databases, knowledge graphs, or data structures. In one example, user account(s) and activity data 242 may be determined using calendar information from one or more user calendars, such as office calendars, personal calendars, social media calendars, or even calendars from family members or friends of the user, in some instances. Moreover, some embodiments of the disclosure may construct a complementary or shadow calendar for a user, as described herein, which may be stored in user account(s) and activity data 242. As discussed hereinabove, user devices 244 may include data elements produced by user devices 102a-102b including, but not limited to, real-time user device location data and past user device location data related to prior meetings.

Organizational profile 246 may include organizational data related to the user (title, role, hierarchy, etc.). Organizational data may comprise any data relating to the user, particularly within the context of a the user's place of work, including an organizational group or department, an area of expertise or specialization, frequent contacts, networks (including business-related social networks or connections, such as Jammer, Lync, etc.), and reporting relationships, among others. User patterns 248 may include information relating to the user and meeting patterns, behavior, or models. For example, as will be discussed in more detail below, meeting patterns for the user determined by the inference engine 230 and effectiveness scores generated by effectiveness determiner 220 may be stored in user patterns 246a and/or 246b. Effectiveness determiner 220 is generally responsible for generating effectiveness scores that reflect an online meeting's effectiveness, and may be based, at least in part, on the meeting features determined by the meeting monitor 210. Effectiveness scores may be determined based on derived meeting effectiveness data and/or explicit meeting effectiveness data, and, in one example, may be represented as numeric values. In some aspects, the derived effectiveness scores and explicit effectiveness scores may be combined to determine a resulting effectiveness score. For instance, derived effectiveness scores may be determined, for example, using rules or heuristics, as further described herein. Explicit meeting effectiveness scores may be determined from explicit feedback provided by participants, including questionnaires, surveys, or any other type of explicit participant feedback. Additionally, effectiveness scores may be determined at a global level, which reflects how effective a meeting was for all participants, and at participant-specific level, which reflects how effective the meeting was for each participant.

Derived effectiveness determiner 222 is generally responsible for determining meeting effectiveness with respect to the participant-specific and global meeting features determined by meeting monitor 210. The derived effectiveness determiner may include a participant-specific derived effectiveness determiner 222a and a global derived effectiveness determiner 222b. Participant-specific effectiveness scores may be determined with respect to each feature associated with the meeting. For example, a participant effectiveness score may be determined for a duration feature, which represents the effectiveness of the meeting based on how long the meeting was. Continuing with this example, if the meeting was two hours long, and effectiveness logic 293 determines that one hour is an effective duration for the participant, a relatively low duration effectiveness score (e.g., 3 out of 10) may be determined. In another example, a participant effectiveness score may be determined for a participant relevance feature, which may represent how relevant a topic of the meeting was to the participant, for example based on the participant's specialty or area of expertise. Continuing with this example, if the meeting topic was data security, and the participant's area of expertise is data security, a relatively high effectiveness score (e.g., 10 out of 10) for the participant relevance may be determined.

Global derived effectiveness determiner 222b may operate to determine derived effectiveness scores for the meeting at a global level, which reflects how effective the meeting was for all participants. For example, a meeting turnout effectiveness score may be generated determined based on the turnout feature determined by meeting monitor 210. In a simplified example, if the turnout for the meeting was determined to be 73%, global derived effectiveness determiner 222b may determine that the turnout was low (e.g., using rules or heuristics from effectiveness logic 293), and determine a low turnout effectiveness score (e.g., 3 out of 10).

Explicit effectiveness determiner 224 is generally responsible for determining explicit meeting effectiveness scores, which may be determined from explicit feedback provided by participants, including questionnaires, surveys, or any other type of explicit participant feedback (which may be detected by meeting features detector 213). Similar to derived effectiveness determiner 222, explicit effectiveness determiner 224 may include a participant-specific explicit effectiveness determiner 224a and a global explicit effectiveness determiner 224b. As can be appreciated, participant-specific explicit effectiveness determiner 224a may be responsible for determining explicit effectiveness scores for each individual participant and global explicit effectiveness determiner 224b may be responsible for determining explicit effectiveness scores for the meeting, with respect to all participants.

Effectiveness score generator 226 is generally responsible for combining derived and explicit effectiveness to determine effectiveness scores that reflect an aggregation of the effectiveness determined by derived effectiveness determiner 222 and explicit effectiveness determiner 224. In an embodiment, the combined or resulting effectiveness scores are represented as one or more vectors or as entries within a meeting-features vector, as described herein. In some aspects, effectiveness scores for certain features may be weighted according to their importance, relevance, or usefulness. For example, logic 293 may contain rules for assigning a weight to features based on any number of variables associated with an online meeting. In some embodiments, these weighted features are determined based on user preferences or settings (which may include privacy settings), or may be learned from past/historic meetings, which may include similar meetings with other users (crowd-sourced information). For instance, using explicit meeting-effectiveness feedback from historic meetings, it may be determined which features are more indicative (or predictive) of effective or ineffective meetings. These features may be weighted more than other features. In this way, some embodiments of the disclosure are adaptive and “learn” or improve, as circumstances change.

The participant-specific effectiveness scores may include an overall participant effectiveness score, which represents how effective a given meeting was for a user across all features. Additionally, participant-specific effectiveness scores may be determined with respect to each feature associated with the meeting. For example, a participant effectiveness score may be determined for a duration feature, which represents the effectiveness of the meeting based on its length. In another example, a participant effectiveness score may be determined for a participant relevance feature, which may represent how relevant a topic of the meeting was to the participant, for example based on the participant's specialty or area of expertise. Combining the above examples, the participant duration effectiveness score for the meeting may be low, for example if the meeting was two hours long and one hour is an effective duration for the participant, while the participant relevance effectiveness score may be high, for example if the meeting topic was data security and the participant's area of expertise is data security. Accordingly, the participant duration effectiveness score, the participant relevance effectiveness score, and effectiveness scores for all other features of the meeting may be combined or aggregated to determine a participant-specific overall effectiveness score.

Similar to the participant-specific effectiveness scores, the global effectiveness scores may include an overall score, or aggregation of derived and explicit effectiveness scores for all meeting features. Accordingly, in overall effectiveness score may represent the effectiveness of the meeting was for all participants. The global effectiveness score may also include feature-specific effectiveness scores, which reflect aggregate effectiveness scores for all participants for all meeting features. For example, effectiveness scores of each meeting participant with respect to a time/day feature may be aggregated to determine a global time/day effectiveness score for the meeting.

Inference engine 230 is generally responsible for predicting an effectiveness of future meetings and providing recommendations to optimize future meetings in order to maximize effectiveness. In some embodiments, features of a proposed/future meeting are detected. The proposed-meeting features may be used to identify prior similar meetings at a global and/or per-participant level. For example, the proposed meeting features may include a day/time feature that can be used to identify prior meetings with a similar day/time features and corresponding global effectiveness scores. Additionally, the proposed features may include participants or participants. Accordingly, participant effectiveness scores for prior similar meetings, or historical meetings having common features with the proposed meeting, may be identified for each participant. The set of identified similar prior meetings and their corresponding effectiveness scores then may be used to infer an effectiveness score (or scores) for the proposed meeting. Further, recommended meeting features may be generated that optimize the inferred effectiveness score for the future meeting.

Still further, using the determined meeting features, global meeting patterns may be determined by identifying semantically related features and determining correlations between the features. Accordingly, meetings having similar patterns and/or similar global effectiveness scores for a given feature may be clustered or grouped to provide models for determining inferences regarding future meetings or proposed future meetings. Similarly, the participant inferences and/or patterns may be determined based on participant effectiveness scores and related data for all meetings in which a participant has participated. As a result, patterns relating to each participant and effectiveness scores for any number of features may be identified and clustered, or grouped, to provide models for predicting a measure of effectiveness of future meetings (including proposed future meetings) for the participant.

Semantic information analyzer 232 is generally responsible for determining semantic information associated with the meeting features and effectiveness scores. A semantic analysis is performed on data related to the identified meetings and features, which may include the contextual information, to characterize aspects of the meetings and features. For example, in some embodiments, activity features associated with an online meeting may be classified or categorized (such as by type, time frame or location, work-related, home-related, themes, related entities, other user(s) (such as communication to or from another user) and/or relation of the other user to the user (e.g., family member, close friend, work acquaintance, boss, or the like), or other categories), or related features may be identified for use in determining a similarity or relational proximity to other meeting-related events, which may indicate a pattern. In some embodiments, semantic information analyzer 232 may utilize a semantic knowledge representation, such as a relational knowledge graph. Semantic information analyzer 232 may also utilize semantic analysis logic, including rules, conditions, or associations to determine semantic information related to the user activity.

Examples of extracted meeting-related activity information may include app usage, online activity, searches, calls, usage duration, application data (e.g. meeting requests, emails, messages, posts, user profile status, notifications, etc.), or nearly any other data related to a user that is detectable via one or more user devices or computing devices, including user interactions with the user device, activity related to cloud services associated with the user (e.g., calendar or scheduling services), online account activity (e.g. email and social networks), and social network activity.

Context variables may be stored as a related set of contextual information associated with the meeting, and may be stored in a user profile 240, such as in user patterns 248. In some cases, contextual information may be used as context-related meeting features by 232 232, such as for determining semantic information or identifying similar meeting features (including context-related features) in meetings to determine a meeting pattern. Contextual information also may be determined from the user data of one or more users, in some embodiments, which may be provided by data collection component 202 in lieu of or in addition to user meeting information for the particular user. In an embodiment, the contextual information is stored with the corresponding meeting(s) in user patterns 248 in user profile 240.

Semantic information analyzer 232 may also be used to characterize contextual information associated with the meeting-related event, such as determining that a location associated with the activity corresponds to a hub or venue of interest to the user (such as the user's home, work, gym, or the like) based on frequency of user visits. For example, the user's home hub may be determined (using semantic analysis logic) to be the location where the user spends most of her time between 8 PM and 6 AM. Similarly, the semantic analysis may determine time of day that corresponds to working hours, lunch time, commute time, etc. Similarly, the semantic analysis may categorize the activity as being associated with work or home, based on other characteristics of the activity (e.g., a batch of online searches about chi-squared distribution that occurs during working hours at a location corresponding to the user's office may be determined to be work-related activity, whereas streaming a movie on Friday night at a location corresponding to the user's home may be determined to be home-related activity). In this way, the semantic analysis provided by semantic information analyzer 232 may provide other relevant features of the meeting-related events that may be used for determining user activity patterns. For example, where the user activity comprises visiting CNN.com over lunch, and the semantic analysis determines that the user visited a news-related website over lunch, a pattern of user activity may be determined (by meeting pattern determiner 236) indicating that the user routinely visits news-related websites over lunch, but only occasionally visits CNN.com as one of those news-related websites.

Features similarity identifier 234 is generally responsible for determining similarity of features of two or more online meetings (put another way, features characterizing a first online meeting that are similar to features characterizing a second online meeting). The features may include features relating to contextual information and features determined by semantic information analyzer 232. Meetings having in-common features may be used to identify a meeting patterns, which may be determined using meeting pattern determiner 236.

For example, in some embodiments, features similarity identifier 234 may be used in conjunction with meeting pattern determiner 236 to determine a set of online meetings that have in-common features. In some aspects, such as the example embodiment shown in online meeting optimization system 200, meeting pattern determiner 236 includes a participant specific meeting pattern determiner 236a and a global meeting patterns determined 236b. In some embodiments, this set of online meetings may be used as inputs to a pattern-based predictor, as described below. In embodiments where features have a value, similarity may be determined among different features having the same value or approximately the same value, based on the particular feature.

In some embodiments, meeting pattern determiner 236 provides a pattern of online meeting and an associated confidence score regarding the strength of the user pattern, which may reflect the likelihood that future online meeting will follow the pattern. More specifically, in some embodiments, a corresponding confidence weight or confidence score may be determined regarding a determined online meeting pattern. The confidence score may be based on the strength of the pattern, which may be determined based on the number of observations (of a particular online meeting) used to determine a pattern, how frequently the user's actions are consistent with the pattern, the age or freshness of the activity observations, the number of similar features, types of features, and/or degree of similarity of the features in common with the activity observations that make up the pattern, or similar measurements.

In some embodiments, a minimum confidence score may be needed before using the pattern. In one embodiment, a threshold of 0.6 (or just over fifty percent) is utilized such that only patterns having a 0.6 (or greater) likelihood of predicting online meeting may be provided. Nevertheless, where confidence scores and thresholds are used, determined patterns of online meeting with confidence scores less than the threshold still may be monitored and updated based on additional activity observations, since the additional observations may increase the confidence for a particular pattern.

Some embodiments of meeting pattern determiner 236 determine a pattern according to the example approaches described below, where each instance of an online meeting has corresponding historical values of tracked activity features (variables) that form patterns, and where meeting pattern determiner 236 may evaluate the distribution of the tracked variables for patterns. In the following example, a tracked variable for an online meeting is a time stamp corresponding to an observed instance of the online meeting. However, it will be appreciated that, conceptually, the following can be applied to different types of historical values for tracked activity features (variables).

Having determined that a pattern exists, or that the confidence score for a pattern is sufficiently high (e.g., satisfies a threshold value), meeting pattern determiner 236 may identify that a plurality of user activities corresponds to an online meeting pattern for the user. As a further example, meeting pattern determiner 236 may determine that an online meeting pattern is likely to be followed by a user where one or more of the confidence scores for one or more tracked variables satisfy a threshold value.

In some embodiments, patterns of online meeting may be determined by monitoring one or more activity features, as described previously. These monitored activity features may be determined from the user data described previously as tracked variables or as described in connection to data collection component 202. In some cases, the variables can represent context similarities and/or semantic similarities among multiple user actions (activity events). In this way, patterns may be identified by detecting variables or features in common over multiple user actions. More specifically, features associated with a first user action may be correlated with features of a second user action to determine a likely pattern. An identified feature pattern may become stronger (i.e., more likely or more predictable) the more often the online meeting observations that make up the pattern are repeated. Similarly, specific features can become more strongly associated with an online meeting pattern as they are repeated.

Future meeting optimizer 250 is generally responsible for determining optimal meeting features, which may include recommended participants, locations, date and/time (which may be provided as a specific date/time or one or more spans of time/dates), subject, duration, or other meeting features. In some embodiments, future meeting optimizer 250 operates in conjunction with a presentation component 204 to provide a user interface for organizing and/or interacting with a proposed meeting. For example, in one embodiment and at a high level, a meeting organizer-user initiates composition of a meeting request or otherwise initiates scheduling a meeting, which invokes future meeting optimizer 250. In an embodiment, future meeting optimizer 250 operates in conjunction with, or is embodied as a component of a meeting scheduling service, which may be cloud-based, such as Microsoft® Exchange. In one embodiment, future meeting optimizer 250 accesses the meeting planning, scheduling, and/or communications resources of Microsoft® Exchange or other mail, calendar, or scheduling services. Future meeting optimizer 250 receives information about the proposed meeting from the meeting organizer, determines optimal meeting features for the proposed meeting, and provides the optimal features as a recommendation, such as a draft meeting invite communication. In one embodiment, future meeting optimizer 250 automatically schedules the meeting or automatically generates and sends a meeting request communication according to the optimal meeting features. Alternatively, in one embodiment, the meeting organizer is provided feedback (which may include visual feedback via presentation component 204) regarding suggestions or recommendations for one or more features. For example, after specifying meeting participants into a meeting planner user interface, future meeting optimizer 250 may determine an optimal time, that maximizes the likelihood of attendance by those participants for which attendance has been determined to be important. (For instance, those participants who are required to be at the meeting.) The user may be shown a notification in or near the meeting planner user interface that reflects the recommended (optimal) features. For example, a suggestion that the meeting organizer change a specific feature such as the time, date, or other feature, an indication as to who is likely to attend/not attend given the current proposed meeting features, or a confirmation that certain participants identified by the meeting organizer are likely to attend given the meeting features for the proposed meeting.

Accordingly, as shown in online meeting optimization system 200, example future meeting optimizer 250 comprises a future meeting features detector 252, similar prior meeting identifier 254, meeting features recommender 256. Embodiments of future meeting optimizer 250, and/or its subcomponents may run on a single computing device, across multiple devices, or in the cloud. For example, in one embodiment where future meeting optimizer 250 operates in conjunction with features provided by Microsoft® Exchange, future meeting optimizer 250 may reside, at least in part on an Exchange server, which may be embodied as server 106, in FIG. 1. Proposed meeting receiving component is generally responsible for receiving meeting information for a proposed, future meeting. The meeting information may be received from a meeting organizer or scheduling service, and may be provided using data collection component 202 and/or presentation component 204. In some embodiments, proposed meeting receiving component 262 extracts meeting features for a proposed meeting from the meeting information. Examples of extracted meeting features may include meeting features similar to those described in connection with meeting features determiner 214 In some aspects, future meeting features detector 252 is configured to receive inputs of meeting features. For example, in an embodiment, future meeting features detector 252 may be configured to receive an indication of one or more meeting participants for a proposed meeting. Among other components of online meeting optimization system 200, the meeting features for a proposed meeting determined by future meeting features detector 252 may be provided to other subcomponents of future meeting optimizer 250. Further, these meeting features may be stored in a user profile associated with the particular meeting organizer, such as in a user profile 240.

Meeting features recommender 256 is generally responsible for determining optimal meeting features for the proposed meeting(s) based on the goals or concerns of the meeting organizer. In some embodiments, meeting features recommender 256 receives features for a proposed meeting, and may also determine importance scores, attendance models, and/or determinations of likelihood of attendance for the meeting participants. In embodiment of meeting features recommender 256 determines a set of optimal meeting features, which as described above, may include optimal, time(s), date(s), duration, as well as other features, in some cases, such as participants or meeting subject(s), to achieve the goals of the organizer (such as maximizing attendance of meeting attendees with the highest importance scores). For instance, the meeting organizer could be interested in scheduling a meeting to in a manner that maximizes the likelihood of attendance by all participants. Alternatively, a meeting organizer may wish to maximize attendance by participants with higher importance scores, or to prioritize the meeting schedule to accommodate those participants having a higher importance score than other participants.

In some aspects, maximizing attendance of meeting attendees with the highest importance scores may be facilitated, for example, by determining optimal meeting features that reconcile meeting importance scores and likelihood of attendance to establish optimal conditions for a meeting. Accordingly, in such embodiments, meeting features recommender 256 may identify meeting features that result in both a high acceptance rate and a high likelihood of the most important meeting participants accepting the invitation. In some embodiments, meeting features recommender 256 uses optimization logic, which may include rules, conditions, associations, classification models, or other criteria to determine optimal features given the meeting organizer's goals or concerns. For example, in one embodiment, the optimization logic may include machine learning and/or statistical classification processes, for instance high-dimensional clustering. In this way, meeting features can be optimized or solved such that the desired attendance goals are achieved.

As described previously, the optimal features may be provided as a recommendation, such as a draft meeting invite communication, may be provided by automatically scheduling the meeting or automatically generating and sending a meeting request communication according to the optimal meeting features. (For instance, a meeting organizer could simply enter the features for a proposed meeting, and click a button “optimize meeting details” which automatically determines optimal meeting features.) In one embodiment, the meeting organizer may be provided with visual indications, within a meeting planning user interface, of suggested optimal meeting features and/or related information, such as importance scores or likelihood of attendance corresponding to the participants. In one embodiment, meeting features recommender 256 may suggest and/or display selectable meeting options to the meeting organizer. The selectable meeting options may include features for one or more meetings, associated with the meeting organizer, that have been identified by meeting features recommender 256. Optimal features may be automatically populated in the selectable meeting options.

In some embodiments, more than one feature may be determined as optimal or otherwise compatible with a meeting organizers goal; for instance more than one date or available location may be likely to result in attendance by more important participants. In some instances, meeting features recommender 256 may provide all of the optimal features so that a meeting organizer can choose which features to apply to the proposed meeting (for example, the meeting organizer may use a meeting planner user interface provided via presentation component 204 and data collection component 202). In other embodiments, meeting features recommender 256 may provide those features that are closest to the original features proposed by the meeting organizer. For instance, if the meeting was originally proposed for Tuesday and meeting features recommender 256 determines that important participants cannot attend Tuesday, but meeting features recommender 256 determines that important Wednesday and Friday are optimal meeting dates, then meeting features recommender 256 may recommend Wednesday, since it is closer to the originally proposed feature date (Tuesday.)

Meeting features recommender 256 provides optimal meeting features to a presentation component 204, and/or other components of online meeting optimization system 200. In some embodiments, the optimal meeting features may be provided to one or more consumer applications or services (not shown) that may use the features for generating a meeting invite, for scheduling, or for planning. Examples of such consumer applications or services include apps such as scheduling or planning apps. In some embodiments, the optimal meeting features and related meeting information may be provided as an API to third party applications or services.

In yet another aspect, online meeting optimization system 200 may include a meeting management dashboard 260. The meeting management dashboard 260 may determine and provide productivity related information for a user or users, such as meeting effectiveness scores and meeting features associated with the effectiveness scores. Additionally, the meeting management dashboard 260 may be responsible for generating managerial reports associated with online meetings. For example, the meeting management dashboard may generate key performance indicators (KPIs) associated with a given meeting, all meetings by meeting features, or any other features or variables associated with online meeting optimization system 200.

Additionally, each user of online meeting optimization system 200 may have access to the meeting management dashboard 260. The meeting management dashboard 260 may also be responsible for generating interfaces for interacting with the information determined by online meeting optimization system 200 for creating or modifying customized settings associated with a given user. Meeting management dashboard 260 may include a privacy dashboard for each user, which allows users to modify privacy-related settings. For example, a given user may limit the types of information that online meeting optimization system 200 (and live meeting optimization system 300) may sense, record, track, or otherwise access.

Turning now to FIG. 3, yet another embodiment is provided herein for optimizing live online meetings by detecting live meeting features and generating meeting recommendations based, at least in part, on meeting patterns determined by online meeting optimization system 200 In general, live meeting optimization system 300 may be monitor ongoing meetings in real-time, and data associated with the meetings may be analyzed to provide recommendations/insights to meeting presenters and participants in real-time, or near real-time. Further, features associated with passive participants of the meeting also may be determined. For instance, engagement data for a passive participant, such as messaging or chatting about the meeting, may be identified during the meeting. Additionally, recommendations/insights for presenters and passive participants can be generated and communicated in real-time while the meeting is ongoing. For example, a private message may be communicated to a moderator suggesting that a given participant should be engaged or involved. Such a recommendation may be generated, in one example, based on a determination that the current topic being discussed is associated with an area of expertise of the given participant and the given participant has not yet commented on the topic. In another example, a notification/recommendation may be communicated to a passive participant when a specific presenter is determined to be speaking. For instance, a notification may be generated and communicated to a passive participant if it is determined that the passive participant's boss is currently presenting.

Prior similar meeting determiner 310 is generally responsible for detecting features associated with a live meeting, identifying similar meetings, and identifying patterns from the similar prior meetings. Live meeting feature detector 312 may detect features of a live meeting, for example as described previously with reference to meeting monitor 210, and future meeting Optimizer 250. In some aspects, features of a live meeting may be determined prior to the meeting, for example, from a meeting invitation. However, live meeting feature detector 312 may also dynamically or continually detect features associated with the live meeting. For example, each participant then joins or connects to the meeting may be detected as the meeting is ongoing. Accordingly, meeting patterns relating to the determined features may be determined and prepared for comparison to additional features determined during the meeting. In one example, live meeting feature detector 312 may detect, or infer, that a topic of the live meeting is topic A, and may provide the detected topic to prior meeting pattern extractor 314.

Prior meeting pattern extractor 314 is generally responsible for identifying and extracting meeting patterns or models related to the detected features, and associated effectiveness scores and/or patterns. Continuing with the above example, prior meeting pattern extractor 314 may identify a cluster or group of meetings (e.g., from meeting storage 292), which have been determined by inference engine 230 to be related to topic A. Additionally, prior meeting pattern extractor 314 may extract patterns from the prior meetings, and make the patterns available to the other components of live meeting optimization system 300.

As can be appreciated, prior meeting pattern extractor 314 may also operate dynamically and/or continually. Accordingly, as live meeting feature detector 312 detects new features of the Live Meeting, prior meeting pattern extractor 314 also continually identifies and extract patterns associated with the features. For example, when live meeting feature detector 312 detects that a new participant “B” has joined the meeting, prior meeting pattern extractor 314 may identify and extract meeting patterns or models that are associated with participant B. As can be appreciated, the patterns identified and extracted may include all patterns associated with each identified feature, or may include subsets of patterns. By way of example, prior meeting pattern extractor may identify and extract all patterns associated with participant be, or may identify and extract meetings on topic A in which B was a participant. As will be discussed in more detail below, the extracted patterns may be made available to live recommendation generator 330, which may use the extracted patterns, features determined from signals relating to the meeting in real-time, and logic 293 to generate recommendations in real-time.

Live meeting monitor 320 is generally responsible for is generally responsible for determining and/or detecting meeting features from live online meetings, in real-time, and making the meeting features available to the other components of live meeting optimization system 300. Live meeting monitor 320 may identify features, in some aspects, as described hereinabove with reference to meeting monitor 210.

Live signal collector 322 is generally responsible for detecting, storing, or otherwise obtaining signals generated during a live meeting. During the live meeting, any of the devices (e.g., presenter devices 302a and 302b, and user devices 304a-304n) may be in communication with one another, for example via network 110. The live meetings discussed herein may include shared documents, presentations, whiteboards, shared screens, audio and/or video, among other items, which are communicated as signals via the network. Additionally, participant activity and engagement data (e.g., from user devices 304a-304n) may be detected (e.g., by the live meeting platform) and communicated via the network 110. Live signal collector 322 may collect data related to the meeting, including data corresponding to the above-noted aspects of the live meeting.

In some aspects, the live signal collector 322 may automatically, and continually or periodically collect all signals or data related to the live meeting. Additionally, the live signal collector may selectively obtain live signals or data, based on a specific feature or features. For example, the live signal collector may selectively obtain signals from a presenter device, such as presenter device 302a. Additionally, in some aspects the live signal collector 322 may also acts as a data link between network 110 and the various devices discussed herein.

Live meeting monitor 320 may also include live signal parser 324, which may be responsible for converting related signals into usable formats for determining presenter and participant meeting features. However, it should be appreciated that some signals or data relating to the may be communicated in a usable format. Accordingly, in one aspect, live signal parser 324 may determine some meeting related features from a packet header, or other data related to the meeting data.

In some aspects, the live signals may be communicated as packetized or compressed data. For example, a live audio and/or video feed may be compressed (e.g., via a capture board on presenter device 302a) and communicated via network 110 to other devices associated with the (e.g., presenter device 302b and user devices 304a-304n). In some aspects, where a feed includes both audio and video, the live signal parser 324 may identify and separate packetized audio and video data. Further, the live signal parser 324 may decompress an audio packet and convert audio data into text, or other format, so that the feed may be analyzed to determine additional meeting features. In some aspects, the live signal parser 324 may prioritize the collected signals. For example, when an identity of a presenter is unknown and a voice signature is required to identify the presenter, an audio packet may be given priority.

Live features determiner 326 is generally responsible for determining features from the live meeting in real-time, or near real-time, and making the features available to live live recommendation generator 330. Similar to the sensed features determiner 217, described hereinabove, the live features determiner 326 includes a live presenter features determiner 326a, a participant features determiner 326b, and a global features determiner 326c. The features identified by live features determiner 326 are determined in real-time from the live meeting signals in a similar manner to those described above with reference to sensed features determiner 217 from recorded or stored meeting and participant data. Accordingly, the full description of determining the meeting features will not be repeated here.

Live recommendation generator 330 is generally responsible for providing recommendations/insights to meeting presenters and participants in real-time, or near real-time. Live recommendation generator 330 may include a feature-pattern matcher 332, a presenter recommendation generator 334, and a participant recommendation generator 336. The recommendations generated by live recommendation generator 330 may be communicated to a device associated with a presenter or participant and maybe presented via presentation component 204.

Feature-pattern matcher 332 may be generally responsible for matching features determined by live features determiner 326 with meeting patterns determined by prior meeting pattern extractor 314. For example, prior meeting pattern extractor 314 extractor patterns related to presenter X, based on a determination that the presenter X was listed as a presenter on an agenda attached to a meeting invitation for the live meeting. Continuing with this example, assume that live presenter features determiner 326a determined that presenter X is currently presenting, by matching a voice profile determined from a live audio feed with presenter X. Accordingly, feature-pattern matcher 332 may provide the extracted patterns relating to presenter X to presenter recommendation generator 334 to determine one or more recommendations.

In another aspect, feature-pattern matcher may obtain prior meeting patterns (e.g., from prior meeting pattern extractor 314) when a feature is detected by live features determiner 326. For example, live presenter features determiner 326a determined that presenter X is discussing topic B. Feature-pattern matcher may request meeting patterns associated with topic B from prior meeting pattern extractor 314, or may obtain meeting patterns related to topic B from meeting storage 292. Feature-pattern matcher 332 may then make the obtained patterns for topic being available to presenter recommendation generator 334 and participant recommendation generator 336.

Presenter recommendation generator 334 is generally responsible for generating and communicating recommendations to presenters based on prior meeting patterns and live determined features. In some aspects, presenter recommendation generator (and participant recommendation generator 336) may apply logic 293 to the prior meeting patterns and live determined features to determine a recommendation for improving the efficiency of the online meeting. A private message, or other communication including the recommendation may be generated and communicated to a meeting presenter. For example, a message may be sent to a presenter suggesting that a given participant should be engaged or involved. Such a recommendation may be generated, in one example, based on a determination that the current topic that the presenter is discussing is associated with an area of expertise of a participant, and the participant has not yet commented on the topic. For example, when it is determined that presenter X is discussing topic B, presenter recommendation generator 334 may determine that participant Y is an expert on topic B, but has not yet commented. Accordingly, presenter recommendation generator 334 may communicate a private message to presenter X recommending that participant Y provide input relating to topic B.

Participant recommendation generator 336 is generally responsible for generating and communicating recommendations to participants based on prior meeting patterns and live-determined features. For example, prior meeting pattern extractor 314 may have extracted information relating to participant Y, based on a determination that participant Y joined the live meeting. The extracted information for the participant Y included a relationship pattern indicating that presenter X is a supervisor for Y's department. Further, live presenter features determiner 326a determined that presenter X is currently presenting. Accordingly, participant recommendation generator 336 may generate and communicate a notification to participant Y indicating that their supervisor is currently presenting.

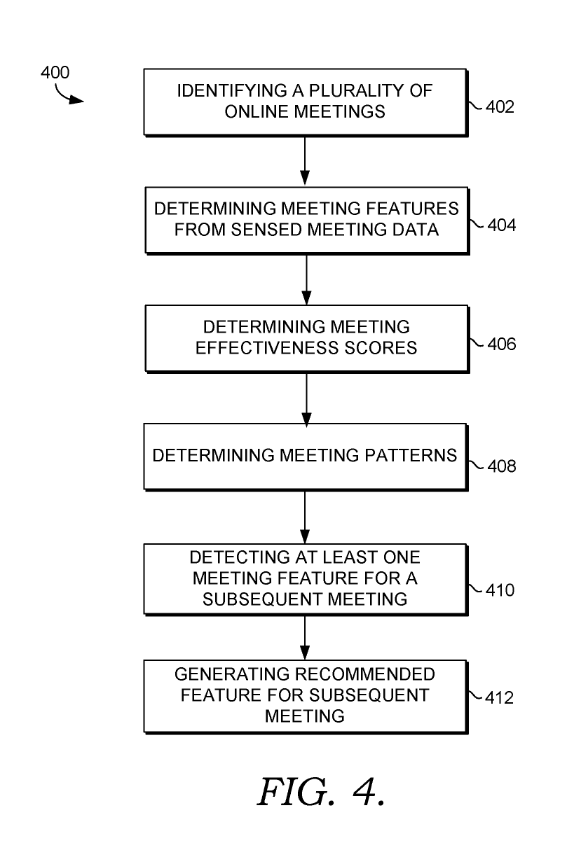

Turning now to FIG. 4, a flow diagram is provided that illustrates a method 400 for providing one or more recommendations for an online meeting. Initially, as shown at block 402, the method includes identifying a plurality of online meetings and corresponding online meeting data, the online meeting data including sensed data. Further, as shown at block 404, the method may include, determining, from the sensed data, one or more meeting features for each meeting of the plurality of online meetings. In some aspects, as shown at block 406, the method comprises generating an effectiveness score for each meeting of the plurality of online meetings, the effectiveness score being based, at least in part, on the one or more meeting features and representing the effectiveness of the online meeting. At block 408, the method may include determining one or more meeting patterns for the plurality of online meetings. As shown at block 410, the method may also include determining at least one feature of a subsequent online meeting. Additionally, in some aspects, as shown at block 412, the method may comprise: based at least in part on the one or more meeting patterns and the at least one feature of the subsequent online meeting, generating at least one recommendation for the subsequent online meeting

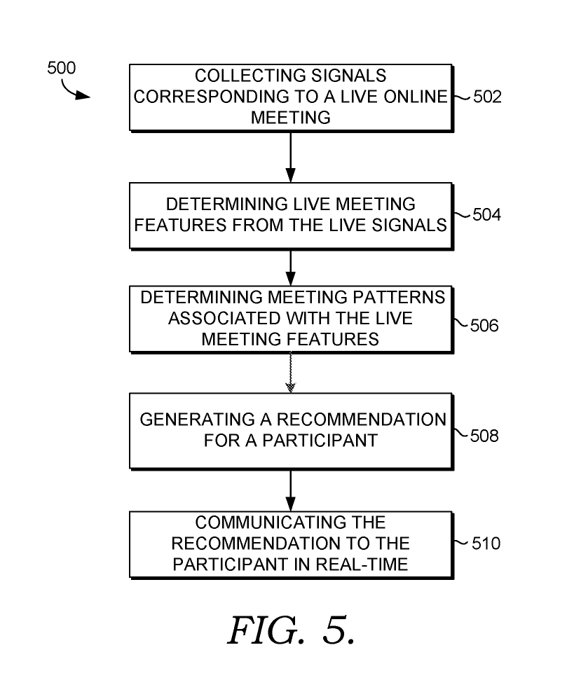

With reference to FIG. 5, a flow diagram is provided that illustrates a method 500 for optimizing live online meetings. Initially, as shown at block 502, the method includes collecting live signals corresponding to a live online meeting. Further, as shown at block 504, the method includes, determining, in real-time, one or more live meeting features from the live signals. At block 506, the method may include identifying one or more meeting patterns associated with the one or more live meeting features. Additionally, in some aspects, as shown at block 512, the method may include generating and communicating at least one live meeting recommendation, the at least one live meeting recommendation being based at least in part on the one or more meeting patterns and the one or more live meeting features.

Accordingly, we have described various aspects of technology directed to systems and methods for providing improved meeting scheduling functionality, which may include meetings optimized for attendance by certain users, and/or determining meeting attendance models based on prior meetings. It is understood that various features, sub-combinations, and modifications of the embodiments described herein are of utility and may be employed in other embodiments without reference to other features or sub-combinations. Moreover, the order and sequences of steps shown in the example methods 400 and 500 are not meant to limit the scope of the present disclosure in any way, and in fact, the steps may occur in a variety of different sequences within embodiments hereof. Such variations and combinations thereof are also contemplated to be within the scope of embodiments of the disclosure.

Having described various embodiments of the disclosure, an exemplary computing environment suitable for implementing embodiments of the disclosure is now described. With reference to FIG. 6, an exemplary computing device is provided and referred to generally as computing device 600. The computing device 600 is but one example of a suitable computing environment and is not intended to suggest any limitation as to the scope of use or functionality of the disclosure. Neither should the computing device 600 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the disclosure may be practiced in a variety of system configurations, including handheld devices, consumer electronics, general-purpose computers, more specialty computing devices, etc. Embodiments of the disclosure may also be practiced in distributed computing environments where tasks are performed by remote-processing devices that are linked through a communications network. In a distributed computing environment, program modules may be located in both local and remote computer storage media including memory storage devices.

With reference to FIG. 6, computing device 600 includes a bus 610 that directly or indirectly couples the following devices: memory 612, one or more processors 614, one or more presentation components 616, one or more input/output (I/O) ports 618, one or more I/O components 620, and an illustrative power supply 622. Bus 610 represents what may be one or more busses (such as an address bus, data bus, or combination thereof). Although the various blocks of FIG. 6 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 6 and with reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors 614 that read data from various entities such as memory 612 or I/O components 620. Presentation component(s) 616 presents data indications to a user or other device. Exemplary presentation components include a display device, speaker, printing component, vibrating component, and the like.

The I/O ports 618 allow computing device 600 to be logically coupled to other devices, including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

Some embodiments of computing device 600 may include one or more radio(s) 624 (or similar wireless communication components). The radio 624 transmits and receives radio or wireless communications. The computing device 600 may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility, may be employed without reference to other features and sub-combinations, and are contemplated within the scope of the claims.

What is claimed is:

1. A computerized system comprising:
one or more sensors configured to provide sensor data;
one or more processors; and
one or more computer storage media storing computer-useable instructions that, when executed by the one or more processors, implement a method comprising:
identifying a plurality of online meetings and corresponding online meeting data, the online meeting data including sensed data;
determining, from the sensed data, one or more meeting features for each meeting of the plurality of online meetings;
generating an effectiveness score for each meeting of the plurality of online meetings, the effectiveness score being based, at least in part, on the one or more meeting features and representing the effectiveness of the online meeting;
determining one or more meeting patterns for the plurality of online meetings;
determining at least one feature of a subsequent online meeting; and
based at least in part on the one or more meeting patterns and the at least one feature of the subsequent online meeting, generating at least one recommendation for the subsequent online meeting.

2. The system of claim 1, wherein the subsequent online meeting is a future online meeting.

3. The system of claim 2, wherein the at least one recommendation includes a recommended feature.

4. The system of claim 1, wherein the subsequent online meeting is a live online meeting.

5. The system of claim 4, further comprising collecting live signals corresponding to the live online meeting.

6. The system of claim 5, further comprising determining, in real-time, one or more live meeting features.

7. The system of claim 6, further generating, in real-time, one or more live meeting recommendations based at least in part on the one or more meeting patterns and the one or more live meeting features.

8. The system of claim 7, further comprising communicating the one or more live meeting recommendations to a meeting presenter in real-time.

9. The system of claim 7, further comprising communicating the one or more live meeting recommendations to a meeting participant in real-time.

10. A system comprising:
one or more sensors configured to provide sensor data;
one or more processors; and
one or more computer storage media storing computer-useable instructions that, when executed by the one or more processors, implement a method comprising:
determining a plurality of online meetings and one or more meeting features for each meeting of the plurality of online meetings, the one or more meeting features being based, at least in part, on sensed data associated with the plurality of online meetings;
generating a global effectiveness score for each meeting of the plurality of online meetings;
determining one or more meeting patterns for the plurality of online meetings, the one or more meeting patterns being based, at least in part, on the one or more features;
determining at least one feature of a subsequent online meeting; and
based at least in part on the one or more meeting patterns and the at least one feature of the subsequent online meeting, generating at least one recommendation for the subsequent online meeting.

11. The system of claim 10, wherein the global effectiveness score for each meeting of the plurality of online meetings is based, at least in part, on a derived effectiveness score and an explicit effectiveness score.

12. The system of claim 11, wherein the derived effectiveness score is determined based on one or more of rules and heuristics.

13. The system of claim 11, wherein the explicit effectiveness score is determined based on explicit feedback provided by meeting participants.

14. The system of claim 10, further comprising generating a participant effectiveness score for each participant of each meeting of the plurality of online meetings.

15. One or more computer storage devices storing computer-useable instructions that, when used by one or more computing devices, cause the one or more computing devices to perform a method for optimizing live online meetings, the method comprising:
collecting live signals corresponding to a live online meeting;
determining, in real-time, one or more live meeting features from the live signals;
identifying one or more meeting patterns associated with the one or more live meeting features; and
generating and communicating at least one live meeting recommendation, the at least one live meeting recommendation being based at least in part on the one or more meeting patterns and the one or more live meeting features.

16. The method of claim 15, wherein the at least one live meeting recommendation includes a suggestion for improving the efficiency of live meeting and is communicated to one of a meeting presenter and a meeting participant.

17. The method of claim 15, wherein the live signals comprise a live video feed from a presenter device.

18. The method of claim 17, wherein the one or more live meeting features are determined from the live video feed and comprise one or more of a meeting topic and an identity of a current presenter.

19. The method of claim 15, wherein the live signals comprise engagement data from a participant device.

20. The method of claim 19, wherein the one or more features are determined from the engagement data from the participant device and include one or more of:
a peripheral activity feature;
a meeting interaction feature;
a participant relevance feature; and
a relationship feature.
